(19) United States
(12) Patent Application Publication
(10) Pub. No.: US 2005/0087729 A1
(43) Pub. Date: Apr. 28, 2005

(54) Impact cap for pry bar and method for producing

(75) Inventor: Jeffrey A. Mitcheltree, Cuyahoga Falls, OH (US)

Correspondence Address: HAHN LOESER & PARKS, LLP, One GOJO Plaza, Suite 300, AKRON, OH, 44311-1076, US

(73) Assignee: NMTC Inc.

(21) Appl. No.: 10/695,662

(22) Filed: Oct. 28, 2003

(51) Int. Cl. B66F 15/00

(52) U.S. Cl. 254/25

(57) ABSTRACT

A screwdriver style pry bar comprising a handle member, a pry bar shank, and an impact cap. The impact cap is positioned on an end of the handle opposite the pry bar shank. The impact cap allows the pry bar to withstand impact blows without damaging the handle.

### TECHNICAL FIELD

The present invention relates to a pry bars. Specifically, this invention relates to a metal striking cap or anvil positioned on the end of a screwdriver style pry bar handle that is able to transfer impact shock loads directly to the shank of a pry bar.

### BACKGROUND OF THE INVENTION

Screwdriver style pry bars resemble a giant screwdriver and typically consist of an elongated metal bar with a handle opposite a working end typically in the form of a flat head screwdriver. The working end may be straight or slightly curved to help provide a fulcrum for the prying action of the tool. The pry bars are made in different lengths varying typically from 12 to 42 inches.

A major problem with prior art screwdriver style pry bars is that the user will often strike the end of the handle with a hammer or mallet to force the working end into a desired position. The handle is typically made of cellulose acetate or some other plastic material which can be broken by the hammer impact.

Accordingly, there is a need for a screwdriver style pry bar that can withstand repeated impact blows to the non-working end of the pry bar without damaging the plastic handle.

### SUMMARY OF THE INVENTION

The present invention overcomes at least one disadvantage of prior art screwdriver style pry bars by providing a screwdriver style pry bar comprising a handle member having a first end, a second end, and an aperture through the longitudinal axis thereof; an elongated metal shank member having a first end positioned within the aperture of the handle member, the shank member extending from the first end of the handle member; and a metal impact cap having a first end positioned within the aperture of the handle member, and a second end extending from the second end of the handle member.

The present invention also provides a method for making a pry bar comprising the steps of providing a cylindrical metal impact cap; molding a handle having a longitudinal aperture around the cylindrical metal impact cap such that an end of the impact cap protrudes from a first end of the handle; and inserting a metal pry bar shank into the end of the longitudinal aperture in the handle.

### BRIEF DESCRIPTION OF THE DRAWINGS

FIG. 1 is an exploded perspective view of the pry bar of the present invention;

FIG. 2 is a perspective view of the nesting impact cap of the present invention as shown in FIG. 1;

FIG. 3 is an exploded view of the pry bar shank and the nesting impact cap shown in FIG. 1;

FIG. 4 is a perspective view of the pry bar shank nested in the impact cap; and

FIG. 5 is a perspective view of the assembled pry bar of the present invention.

### DETAILED DESCRIPTION OF THE INVENTION

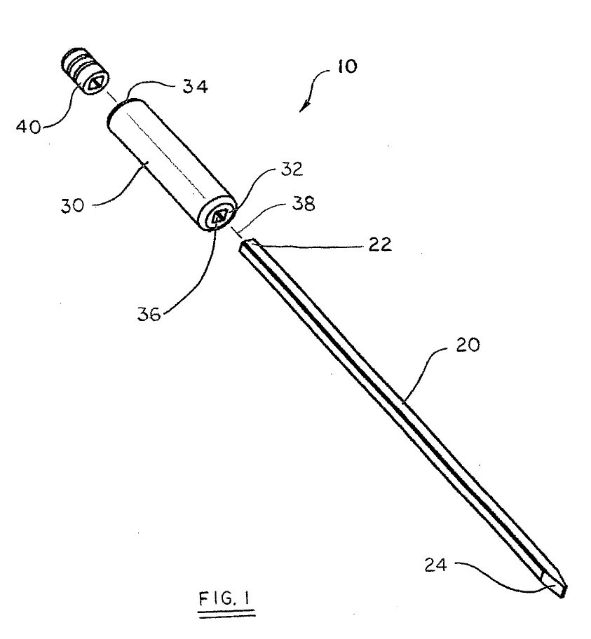

Referring to FIG. 1, a first embodiment of the pry bar assembly 10 is shown in an exploded perspective view. The pry bar assembly 10 comprises an elongated pry bar shank 20, a handle 30, and an anvil or impact cap 40. The pry bar shank 20 has a first end 22, and a second end 24 in the form of a flat head screwdriver. The shank 20 is made of metal and typically has a square cross-section in a ⅜″, ½″, or ⅝″ size. Although not shown, the second end 24 may also be slightly curved as is known in the art. The handle 30 has a first end 32, a second end 34, and an aperture 36 formed through the longitudinal axis 38 of the handle 30. The handle 30 is typically manufactured of a plastic material and is generally cylindrical, however, the present invention is not limited to a particular shape of handle and may include styles such as ergonomically shaped handles.

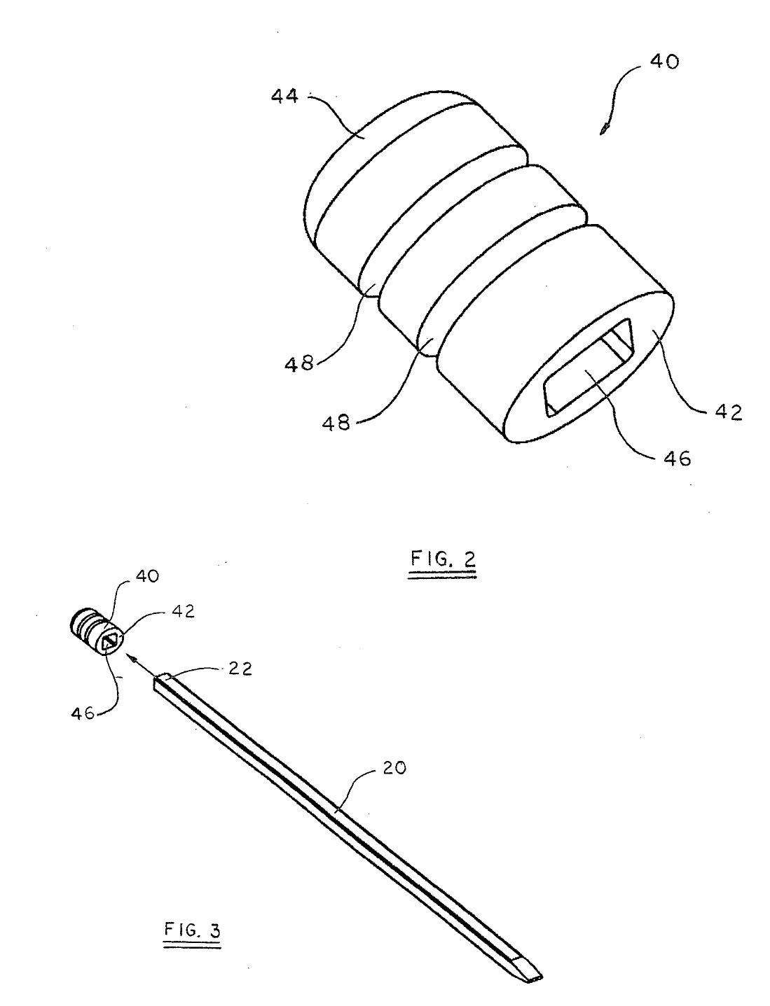

The impact cap 40 is best shown in FIG. 2 and has a first end 42, a second end 44, and a closed aperture 46 formed in the second end 44. The impact cap 40 may be cylindrical. In one embodiment, the impact cap 40 may include a means 48 for securing the impact cap to handle 30. While means 48 is shown as a pair of grooves in FIG. 2, it is also contemplated that knurling, radially extending flanges, or other surface features may help attach the impact cap 40 to the handle 30 as the plastic handle 30 is molded about the impact cap 40 during manufacturing.

The impact cap 40 will help protect the end of the handle 30 from impacts from a hammer. However, if the impact cap 40 is solely supported by the handle 30, the plastic handle 30 may still be damaged by the transfer of the impact force through the impact cap 40 and directly into the handle body 30. In a second embodiment, it is contemplated that the first end 22 of the shank 20 is inserted into the handle 30 until the first end 22 is abutted adjacent to and in contact with impact cap 40. In this manner, impact forces will be transmitted through the impact cap 40 directly to the shank 20. However, a user still may be able to damage the handle 30 with an off-center strike or impact that is oblique to the impact cap 40. These forces may still be transmitted, at least partially, to the handle and, if severe enough, cause damage to the handle.

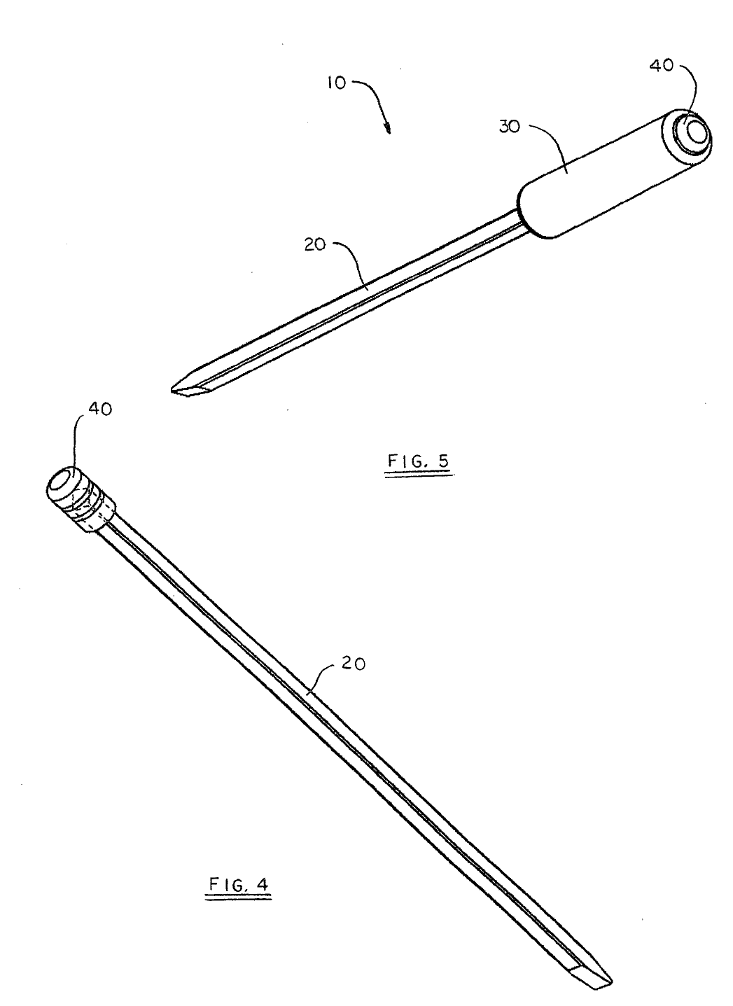

In another embodiment of the present invention, as best shown in FIGS. 3 and 4, the first end 42 of the impact cap 40 comprises a closed aperture 46 which allows a nesting connection with the first end 22 of the shank 20. The nesting connection, shown in phantom in FIG. 4, of the impact cap 40 and the shank 20 allows oblique blows to the impact cap 40 to be directly transmitted to the shank without the risk of damage to the handle 30.

With prior art screwdriver style pry bars, the handle is typically molded with a closed end aperture that provides an interference fit with a metal shank inserted into the aperture. One prior art design uses a handle with a square aperture and interference dimples that help retain the shank within the handle once the shank is inserted. The present invention is manufactured as follows. An impact cap is formed similar to that of a metal socket. The closed end of the metal impact cap may be machined to be rounded, and grooves or other gripping surfaces are cut into the exterior of the cap. The handle is molded with the impact cap in place along with a central longitudinal aperture. The plastic handle material conforms to the exterior of the cap and the grooves which help retain the cap in position in the end of the handle such that an end of the impact cap protrudes from the second end of the handle. The pry bar shank is then inserted into the molded handle.

In one embodiment, appropriate tooling is produced such that the pry bar shank is inserted into the handle until the shank contacts the impact cap but does not push the impact cap out of the handle. In using an impact cap with an aperture, the shank is inserted into the handle until the shank contacts the bottom of the aperture. The shank is held in place due to an interference fit with the handle as is known in the art.

It is also contemplated that the handle may be molded over top of the shank with the impact cap nested on the end of the shank. The impact cap may need to be held against the shank by glue or the like to prevent a gap from forming between the shank and the cap.

Although the principles, embodiments, and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims

1. A screwdriver style pry bar comprising:
a handle member having a first end, a second end, and an aperture through the longitudinal axis thereof;
an elongated metal shank member having a first end positioned within the aperture of the handle member, the shank member extending from the first end of the handle member;
a metal impact cap having a first end positioned within the aperture of the handle member, and a second end extending from the second end of the handle member.

2. The pry bar of claim 1, wherein the first end of the impact cap is positioned adjacent to and in contact with the first end of the shank member.

3. The pry bar of claim 2, wherein the first end of the impact cap comprises an aperture.

4. The pry bar of claim 3, wherein the first end of the shank member is positioned within the aperture of the impact cap.

5. The pry bar of claim 3, wherein the cylindrical body of the impact cap comprises an exterior surface configured to improve the attachment of the impact cap to the handle.

6. The pry bar of claim 5, wherein the exterior surface of the cylindrical body of the impact cap comprises a groove positioned circumferentially thereon.

7. The pry bar of claim 1, wherein the second end of the impact cap comprises a rounded surface.

8. A screwdriver style pry bar comprising:
a plastic handle member having a first end, a second end, and an aperture through the longitudinal axis thereof;
an elongated metal shank member having a first end positioned within the aperture of the handle member, the shank member extending from the first end of the handle member;
a metal impact cap having a first end positioned within the aperture of the handle member, and a second end extending from the second end of the handle member;
wherein the first end of the impact cap comprises an aperture and the first end of the shank member is positioned within the aperture of the impact cap such that the impact cap is positioned adjacent to and in contact with the first end of the shank member.

9. The pry bar of claim 8, wherein the impact cap comprises an exterior surface comprising means for securing the impact cap to the handle.

10. The pry bar of claim 9, wherein the means for securing the impact cap to the handle comprises a groove formed circumferentially on the exterior surface of the impact cap.

11. The pry bar of claim 8, wherein the second end of the impact cap comprises a rounded surface.

12. A method for making a pry bar comprising the steps of:
providing a cylindrical metal impact cap;
molding a handle having a longitudinal aperture around the cylindrical metal impact cap such that an end of the impact cap protrudes from a first end of the handle; and
inserting a metal pry bar shank into the end of the longitudinal aperture in the handle.

13. The method of claim 12 further comprising the step of inserting the pry bar shank into the handle until the shank contacts the impact cap.

14. The method of claim 12 further comprising the step of inserting the pry bar shank into the handle until the shank is nested in an aperture in the impact cap.

15. The method of claim 12 further comprising the step of molding a portion of the handle into a groove in the impact cap.
